(19) United States
(12) Patent Application Publication
(10) Pub. No.: US 2005/0030156 A1
(43) Pub. Date: Feb. 10, 2005

(54) Long-range wireless vehicle command system

(76) Inventors: Ronel Alfonso, Bradford (CA); Miguel Angel Rojas, Toronto (CA); Marlene Falcon, Bradford (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/896,871

(22) Filed: Jul. 23, 2004

Related U.S. Application Data
(60) Provisional application No. 60/489,477, filed on Jul. 24, 2003.

(51) Int. Cl. G06F 7/00

(52) U.S. Cl. 340/5.61

(57) ABSTRACT

The invention comprises a long-range wireless vehicle command system that can be used to provide commands to a conventional remote vehicle starter over long distances. The long-range wireless vehicle command system may be based on existing wireless technology such as a pager and the transmitter of a remote vehicle starter.

### CROSS-REFERENCE TO RELATED APPLICATIONS

This application claims priority from U.S. Provisional Patent Application Ser. No. 60/489,477 filed on Jul. 24, 2003.

### FIELD OF THE INVENTION

The invention relates to a long-range wireless vehicle command system for activating various devices in a vehicle, such as a remote vehicle starter, when the vehicle owner is out of range of the transmitter of the remote vehicle starter.

### BACKGROUND OF THE INVENTION

A remote vehicle starter is used by a vehicle driver to remotely turn on a vehicle in which the remote vehicle starter is installed. This is useful so that the vehicle driver can start and warm up the vehicle without having to physically get inside the vehicle and wait for the vehicle to warm up. This is quite advantageous in cold climates in which it typically takes longer for the vehicle to warm up.

The remote vehicle starter includes a receiver for receiving a command signal that is transmitted by a remote transmitter upon actuation by the vehicle driver. The remote transmitter is embodied within a small hand-held device that has a small keypad interface. The hand-held device is carried by the vehicle driver in his or her pocket. When the vehicle driver chooses to start the vehicle remotely, the vehicle driver presses a button on the keypad interface which causes the remote transmitter to send a wireless command signal to the receiver. Once the receiver receives the command signal, the remote vehicle starter generates signals to start the vehicle.

Unfortunately, the range of typical remote vehicle starters is limited to up to approximately a few hundred feet. This means that the vehicle driver must wait until he or she is in range of the remote vehicle starter (i.e. which is mounted within the vehicle) to send the wireless command signal. This is particularly inconvenient during inclement weather such as snowstorms, rainstorms or hot weather in which the vehicle driver must go outside until he or she is in the transmitting range of the remote vehicle starter to remotely start the vehicle.

In addition, it would be preferable to increase the range of other functions that are related to the vehicle such as opening or locking a vehicle door. This is particularly useful in cases in which the vehicle driver has locked their keys or hand-held transmitter in the vehicle.

### SUMMARY OF THE INVENTION

The invention comprises a long-range wireless vehicle command system that may be based on existing wireless technology such as a pager and the transmitter of a remote vehicle starter. Accordingly, the invention may use a pager-like device and the transmitter of a remote vehicle starter to activate a remote vehicle starter that is placed in a vehicle.

An exemplary embodiment of the invention provides a long-range wireless vehicle system for allowing a vehicle user to remotely command a remote vehicle starter located in a vehicle. The long-range wireless vehicle system comprises a wireless device for receiving a first wireless command signal, the first wireless command signal encoding a vehicle command; a pulse generator connected to the wireless device for generating a second command signal based on the vehicle command; and, a transmitter connected to the pulse generator for transmitting a second wireless command signal to the remote vehicle starter, the second wireless command signal encoding the vehicle command.

The pulse generator may comprise a signal conditioner connected to the wireless device for generating an intermediate command signal; and, a comparator unit connected to the signal conditioner for comparing the intermediate command signal with a reference signal for identifying the vehicle command and providing a comparator output signal.

The wireless vehicle system may further comprise a keypad connected to the pulse generator for providing a keypad command signal encoding the vehicle command.

The wireless vehicle system may further comprise a clock connected to the pulse generator for providing a timer command signal encoding the vehicle command.

The pulse generator may further comprise a master oscillator connected to the signal conditioner for generating the reference signal. The pulse generator may further comprise a buffer unit connected to the comparator unit and the transmitter unit for generating the second command signal in response to at least one of the comparator output signal and the keypad command signal and providing the second command signal to the transmitter unit. The comparator unit may comprise N comparators and the buffer unit may comprise N buffers where N is the number of different vehicle commands.

In addition, the signal conditioner may comprise a voltage isolator and level corrector connected to the wireless device for electrically isolating the wireless device from the pulse generator and shifting the voltage level of the first command signal for generating the intermediate command signal, and the signal conditioner further comprises a differentiating network connected to the voltage isolator and level corrector for generating a trigger signal.

In another aspect, an exemplary embodiment of the invention provides a method for commanding a remote vehicle starter located in a vehicle, the method comprising:
a) transmitting a first long-range wireless command signal encoding a vehicle command;
b) receiving the first long-range wireless command signal and generating a short-range command signal based on the vehicle command; and,
c) generating and transmitting a short-range wireless command signal to the remote vehicle starter, the short-range wireless command signal encoding the vehicle command.

Step (b) of the method may further comprise:
i) generating an intermediate command signal;
ii) generating a reference signal; and,
iii) comparing the intermediate command signal with the reference signal for identifying the vehicle command and providing a comparator output signal.

The method may further comprise providing a keypad command signal encoding the vehicle command.

The method may further comprise providing a timer command signal encoding the vehicle command.

Step (c) of the method may further comprise generating the short-range wireless command signal based on at least one of the comparator output signal and the keypad command signal.

### BRIEF DESCRIPTION OF THE DRAWINGS

For a better understanding of the present invention and to show more clearly how it may be carried into effect, reference will now be made, by way of example only, to the accompanying drawings which show at least one preferred embodiment of the invention and in which:

FIG. 1 is a block diagram of a long-range wireless vehicle command system in accordance with the invention along with a remote vehicle starter;

FIG. 2 is a block diagram of a pulse generator of the long-range wireless vehicle command system of FIG. 1;

FIG. 3a shows a high pass filter that is used in a differentiating network of the pulse generator;

FIG. 3b shows a buffer that is used in a buffer unit of the pulse generator; and,

FIG. 4 is a front view of the input interface of the long-range wireless vehicle command system of FIG. 1.

### DETAILED DESCRIPTION OF THE INVENTION

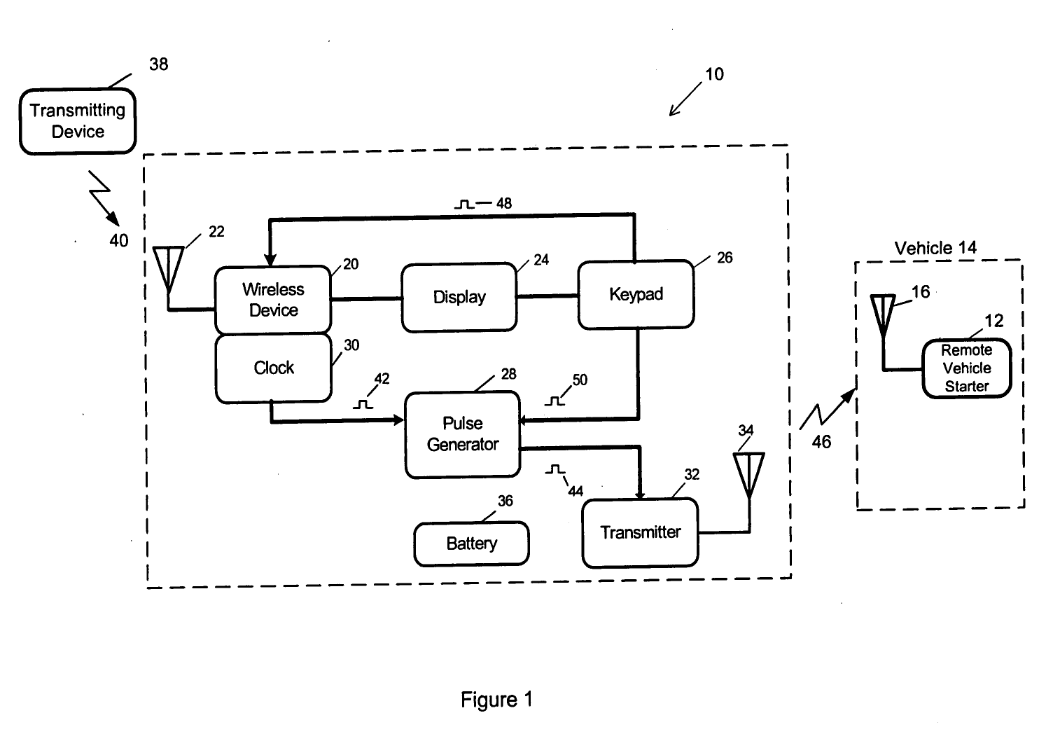

Referring to FIG. 1, shown therein is a block diagram of an exemplary embodiment of a long-range wireless vehicle command system 10 that communicates with a remote vehicle starter 12 for starting a vehicle 14 from a variety of distances including short-range distances (such as less than 50 feet) and long-range distances (such as at least several tens of kilometers). A portion of the long-range wireless vehicle command system 10 may be secured or mounted to the vehicle 14 or may be temporarily placed within the vehicle 14 (such as in the glove compartment).

The remote vehicle starter 12 has a starter antenna 16 and is located in the vehicle 14. The remote vehicle starter 12 can be any conventional remote starter. The remote vehicle starter 12 interfaces with the vehicle 14, as is known to those skilled in the art, to provide a variety of features including remote starting, remote unlocking of the doors of the vehicle 14, remote locking of the doors of the vehicle 14 as well as other commands. These commands are hereafter referred to as the “START”, “LOCK” and “UNLOCK” commands.

The long-range wireless vehicle command system 10 comprises a wireless device 20, a receiving antenna 22, a display 24, a keypad 26, a pulse generator 28, a clock 30, a transmitter 32, a transmitting antenna 34, and a battery 36. The display 24 is connected to the wireless device 20 and the keypad 26. The wireless device 20, the keypad 26, the clock 30 and the transmitter 32 are connected to the pulse generator 28. The receiving antenna 22 is connected to the wireless device 20 and the transmitter 32 is connected to the transmitting antenna 34. The battery 36 provides power and is connected to each component of the long-range wireless vehicle command system 10. The battery 36 may be any suitable power source such as a 9 or 12 V battery or the like.

In use, a transmitting device 38 is used in conjunction with the long-range wireless vehicle command system 10 to provide a first wireless command signal 40 to the transmitting antenna 22. The first wireless command signal 40 may be a variety of commands associated with the operation of the vehicle 14 such as the “START”, “LOCK” and “UNLOCK” commands. The first wireless command signal 40 is then provided to the wireless device 20 which processes the first wireless command signal 40 to provide a first command signal 42. The pulse generator 28 processes the first command signal 42 to provide a second command signal 44. The second command signal 44 is provided to the transmitter 32 which then transmits a second wireless command signal 46 to the remote vehicle starter 14 via the transmitting antenna 34.

The first wireless signal 40 may be any wireless signal that is capable of conveying the appropriate commands. The receiving antenna 22 and the wireless device 20 may be any wireless devices that can receive and process the first wireless command signal 40. Preferably, the first wireless signal 40 is a telephone signal and the wireless device 20 and the receiving antenna 22 are provided by a pager-like device. In this case, the transmitting device 38 is a telephone, cell-phone or the like and the clock 30 can be provided by the wireless device 20. In addition, the keypad 26 can be connected to the wireless device 20 to provide a keypad interface signal 48 to allow the vehicle user to interface with the pager for various purposes such as setting a timer signal via the clock 30.

The transmitting device 38 is used to dial the pager number. A greeting will then ask the caller to enter a numeric sequence (corresponding to one of the aforementioned commands). In an alternative, the vehicle owner may also be asked to enter a security code that is specific to the long-range wireless vehicle command system 10 (this feature prevents theft and unwanted use of the vehicle 14 by others). The pager company will then relay the numeric sequence as the first wireless signal 40 to the pager-like device (i.e. the wireless device 20). Any number of unique numeric sequences may be used to provide commands to the long-range wireless vehicle command system 10. Preferably, there are three unique numeric sequences for the “START”, “LOCK” and “UNLOCK” commands. The numeric sequence is sent to the pager and within seconds the pager will receive the message as long as the vehicle owner is in the coverage area provided by the paging company.

In this case, since a telephone call is used in conjunction with a pager service provider, an individual can provide a command to the vehicle 14 from a very long distance away from the vehicle 14. The distance is associated with the range provided by the service provider which may be as large as a province, state or a country. However, the system 10 is reachable from anywhere in the world provided that access to a telephone-like device is available and the vehicle 14 is within the coverage area provided by the pager service provider. This feature is particularly useful when the vehicle owner has locked the keys in the vehicle 14. In this case, the vehicle owner can “call” the long-range wireless device 10 and provide the UNLOCK command. In addition, in the event of forgetting to lock the doors after leaving the vehicle 14, the vehicle owner can “call” the long-range wireless device 10 and provide the LOCK command.

The long-range wireless vehicle command system 10 may be activated in at least two other ways. For instance, the vehicle owner can use the keypad 26 to set the clock 30 for at least one pre-set time at which the long-range wireless vehicle command system 10 is to automatically start the vehicle 14. In this case, at one of the preset times, the clock 30 generates a timer command signal which is provided in the first command signal 42 and sent to the pulse generator 28. The pulse generator 28 then generates the second command signal 44 based on the timer command signal and provides the second command signal 44 to the transmitter 32. Accordingly, the clock 30 can be used to set a pre-set time as well as display the current time.

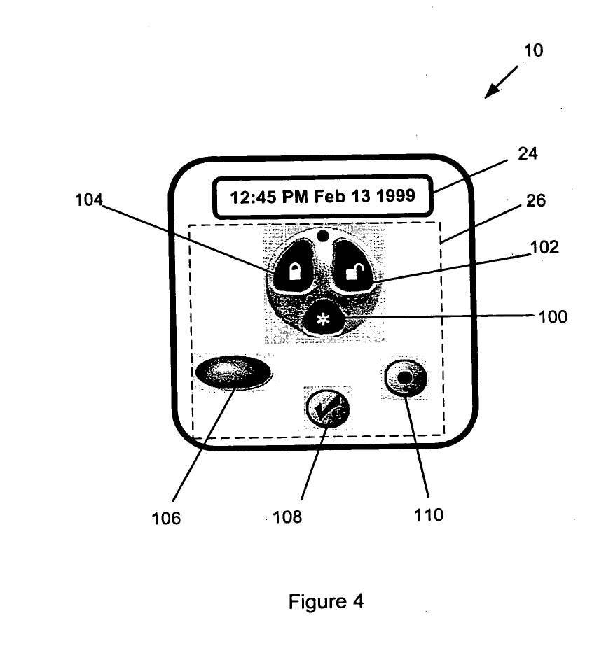

In another instance, the keypad 26 may be used to directly activate the long-range vehicle command system 10. In this case, the vehicle owner carries a device (see FIG. 4) embodying the long-range wireless vehicle system 10 and can use the keypad 26 to send one of the START, LOCK or UNLOCK commands to the remote vehicle starter 12. Accordingly, the keypad 26 is used to generate a keypad command signal 50 which is sent to the pulse generator 28. The pulse generator 28 then generates the second command signal 44 based on the keypad command signal 50 and provides the second command signal 44 to the transmitter 32.

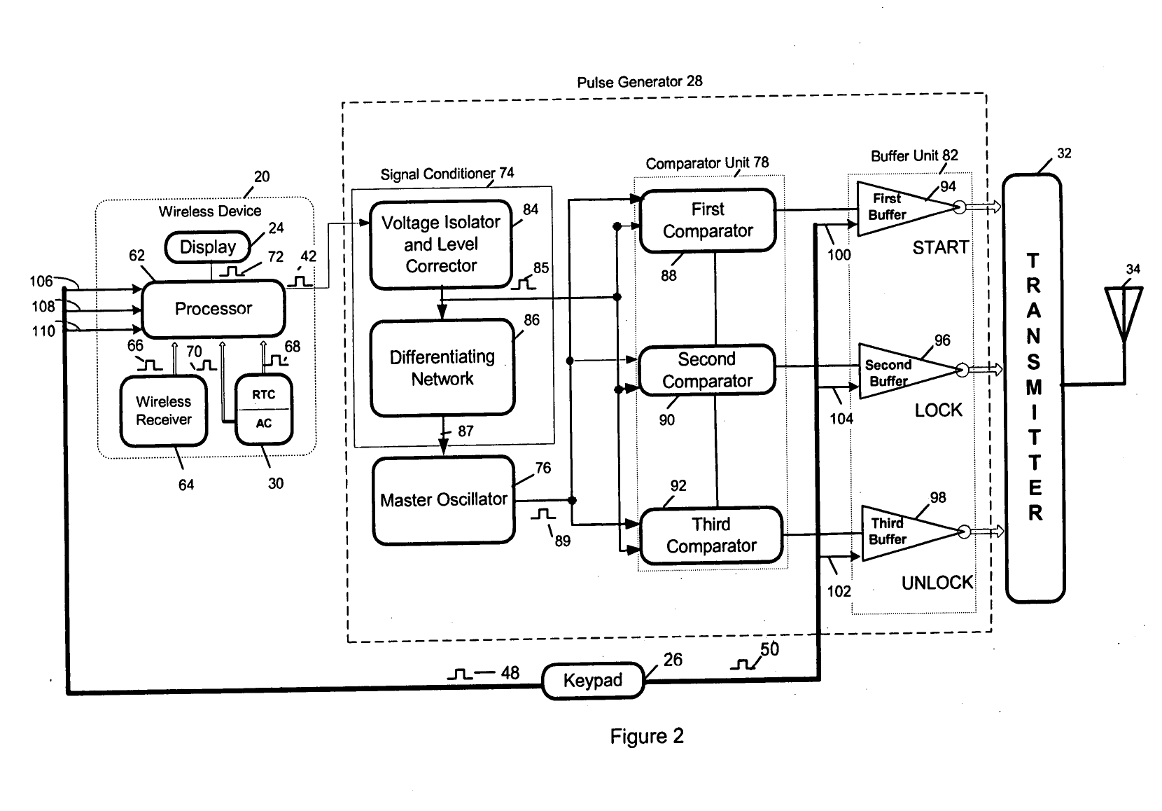

Referring now to FIG. 2, shown therein is a block diagram of the pulse generator 28 of the long-range wireless vehicle command system 10. Also shown in FIG. 2 is the wireless device 20 and the interaction between the pulse generator 28, the keypad 26 and the transmitter 32. In this example, the wireless device 20 is a conventional pager that includes a processor 62, a wireless receiver 64 and provides the display 24 and the clock 30. The processor 62 will receive the keypad interface signal 48 from the keypad 26 to perform all common functions of a pager (i.e. the “read” 106, “menu” 110 or “select” 108 functions; see FIG. 4 for these keys). The clock 30 comprises a real-time clock (RTC) portion and an alarm clock (AC) portion. A single clock device that operates in these two modes may be used to provide this functionality.

The wireless receiver 64 receives the first wireless command signal 40, performs the necessary signal processing on the first wireless command signal 40 to improve signal quality and provides a processed wireless command signal 66 to the processor 62.

The real-time clock portion of the clock 30 provides a real-time signal 68 to the processor 62 so that the actual time can be displayed on the display 24. The alarm clock portion of the clock 30 provides an alarm signal 70 to the processor 62 so that the processor 62 can provide the first command signal 42 to the pulse generator 28 at one of the preset times. In this case, at least one preset time has been programmed into the clock 30. For each programmed preset time, the alarm clock portion keeps track of the preset time and compares the preset time with the actual time provided by the real time clock portion. When the actual time is the same as the preset time, the alarm signal 70 is generated.

The processor 62 processes the processed wireless command signal 66, the real-time signal 68 and the alarm signal 70 to generate the first command signal 42. The first command signal 42 is provided to the pulse generator 28. The time signal 72 is provided to the display 24 for displaying the current time. Alternatively, the processor 62 may use the time signal 72 to display the preset times at which the first command signal 42 is to be generated. The processor 62 typically runs a software program to generate these signals.

The first command signal 42 (via the wireless command signal 40 or the alarm signal 70) and the keypad command signal 50 encode at least one of the START, LOCK and UNLOCK commands. Other commands may also be encoded in these command signals. The first command signal 42 and the keypad command signal 50 are preferably pulse signals with different pulse durations to encode the different commands. For example, the first command signal 42 may be one of three pulses having durations of 2, 8 and 16 seconds to represent the START, LOCK and UNLOCK commands respectively. Accordingly, the pulse duration is used to discriminate between the various commands. Those skilled in the art can appreciate that these durations are used for exemplary purposes only and other durations or types of signals can be used.

The pulse generator 28 comprises a signal conditioner 74, a master oscillator 76, a comparator unit 78, and a buffer unit 82 connected as shown in FIG. 2. These elements are preferably discrete components but may also be implemented using integrated circuits and/or software modules. The transmitter 32 is preferably the transmitter of a conventional remote vehicle starter system. Alternatively, the transmitter 32 may be custom-built to interface with any one of a variety of remote vehicle starter systems.

The signal conditioner 74 receives the first command signal 42 from the wireless device 20 and modifies this signal for processing by the remainder of the units of the pulse generator 28. Firstly, the signal conditioner 74 comprises a voltage isolator and level corrector 84 for electrically isolating the wireless device 20 from the remainder of the pulse generator 28. This is done for safety reasons since the wireless device 20 may be operating at a different voltage than the pulse generator 28. Typically all components of the long-range wireless command system 10 will be operating in a “low power consumption” state or standby mode, and only when the commands are received, the system 10 “wakes up” and functions more completely. The voltage isolator and level corrector 84 may also alter the voltage level of the first command signal 42 for the same reason. However, the pulse durations of this signal are preferably unaltered at this point. The resulting level corrected signal is an intermediate command signal 85 that is then provided from the voltage isolator and level corrector 84 to the differentiating network 86 and the comparator unit 78 with the proper pulse duration depending on the encoded command. Any voltage isolator known to those skilled in the art may be used such as an opto-isolator and the like.

The differentiating network 86 provides additional processing since the signal 42 coming from the wireless device 20 is a pulse with a duration that varies depending on the issued command. These pulse durations are not suitable for triggering the master oscillator 76. Accordingly, the differentiating network 86 processes the first command signal 42 to provide a short spike with the proper polarity to trigger the master oscillator 76.

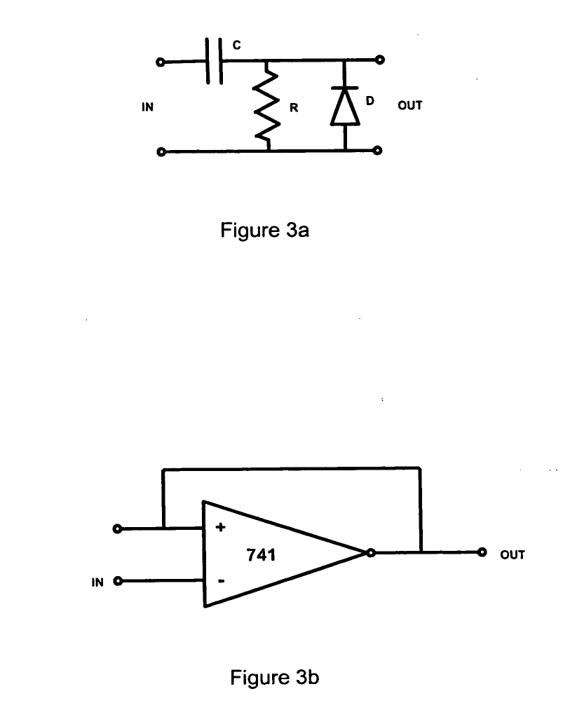

The differentiating network 86 comprises a network of resistors and capacitors for generating a spike from a pulse. In one embodiment, the resistors and capacitors are preferably configured to be a high pass filter. The high pass filter has an appropriate time constant to properly process and adjust the pulse duration of the level corrected signal 85 to produce a trigger signal 87, which is preferably a spike with a short time duration, to trigger the master oscillator 76. Discrete components or an integrated circuit can be used to implement the differentiating network 86. An example of one high pass filter is shown in FIG. 3a. The values of the capacitor and resistor may be selected based on the duration of the short spike in the trigger signal 87. The spike is preferably approximately 10 times shorter than the duration of the reference signal 89. The diode D is used to eliminate any undesirable negative-going spikes from the output of the high pass filter. There is a high-pass filter in the differentiating network 86 for each different pulse duration that may exist in the intermediate command signal 85. The master oscillator 76 provides a reference signal 89 such as a clock signal having an appropriate reference frequency. The reference frequency is chosen such that a unique integer number of cycles of the clock signal occur within the pulse duration of each command that is encoded within the intermediate command signal 85.

The master oscillator 76 operates in a low power consumption mode to conserve power and is activated by the trigger signal 87 that is provided by the signal conditioner 74. Alternatively, the master oscillator 76 may be activated by one of the first command signal 42 or the timer signal. In each of these cases, the first few microseconds of each signal can be used to “wake up” the master oscillator 76. The master oscillator 76 provides the reference signal 89 to the comparator unit 78. The master oscillator 76 may be any off the shelf discrete clock as is commonly known to those skilled in the art.

The comparator unit 78 receives the intermediate command signal 85 and the reference signal 89 and compares these two signals to determine the type of command that is encoded within the intermediate command signal 85. The determination is based on the number of cycles (i.e. a cycle count) that occur in the reference signal 89 during the pulse duration of a pulse that is contained within the intermediate command signal 85. Accordingly, the comparator unit 78 also comprises a counter (not shown).

The comparator unit 78 can generate at least one output comparator signal. The output comparator signal that is generated depends on the vehicle command and has an appropriate pulse duration for encoding the vehicle command. For example, the START command can be encoded with a pulse duration of two seconds and the LOCK and UNLOCK commands can be encoded with short pulse durations on the order of hundreds of milliseconds. The output comparator signal is provided to the buffer unit 82. The buffer unit 82 also receives the keypad command signal 50 when the vehicle owner uses the keypad 26 to activate the long-range vehicle command system 10. The buffer unit 82 then provides an appropriate buffer output as the second command signal 44 to the transmitter 32. The transmitter 32 then transmits the second wireless command signal 46.

In the particular exemplary embodiment of FIG. 2, the comparator unit 78 comprises a first comparator 88, a second comparator 90 and a third comparator 92. Each of the comparators 88, 90 and 92 receive the intermediate command signal 85 and the reference signal 89. In addition, each of the comparators 88, 90 and 92 preferably include a counter (not shown) for determining the cycle count and a gating means, switch or the like (not shown) for generating a pulse with a specific duration in the output comparator signal. Each of the comparators 88, 90 and 92 calculates the cycle count based on the reference signal 89 and the pulse duration of the pulse contained in the intermediate command signal 85 (depending on the mode of activation, i.e. wirelessly or timer). The cycle count is then compared with a reference cycle count that is expected based on one of the commands START, LOCK or UNLOCK and when a match is found the appropriate comparator produces the output command signal. Accordingly, in this exemplary embodiment, the number of comparators is equal to the number of commands. In particular, the first comparator 88 corresponds to the START command, the second comparator 90 corresponds to the LOCK command and the third comparator 92 corresponds to the UNLOCK command. Further, each comparator 88, 90 and 92 will generate the output command signal for a given period of time.

The buffer unit 82 contains a first buffer 94, a second buffer 96 and a third buffer 98. Each of the buffers 94, 96 and 98 correspond to one of the commands and is connected to the appropriately corresponding comparator from the comparator unit 78. The buffers 94, 96 and 98 provide the needed isolation between the control signals provided by the comparator unit 78 and the RF stage of the transmitter 32. An exemplary buffer is shown in FIG. 3b in which a 741 op-amp is connected in a buffer configuration.

In use, the comparator unit 78 and the buffer unit 82 operate in the following fashion. If the command is the START command for example, then the first comparator 88 will generate the output command signal which is then provided to the first buffer 94 which in turn provides a buffer output signal (i.e. the second command signal) to the corresponding input of the transmitter 32 for sending the START command signal as the second wireless command signal 46. Accordingly, in this exemplary embodiment, the comparator unit 78 comprises N comparators and the buffer unit 82 comprises N buffers where N is equal to the number of vehicle commands.

As shown in FIG. 2, the keypad 26 directly interfaces with the buffer unit 82 so that the vehicle owner may use the keypad 26 to activate the system 10. In this case, the appropriate keys, i.e. the START 100, LOCK 104 and UNLOCK 106 keys (see FIG. 4) from the keypad 26 are connected to the appropriate buffers in the buffer unit 82. Accordingly, the buffers 94, 96 and 98 receive inputs from both the comparator unit 78 and the keypad unit 26.

Referring now to FIG. 4, shown therein is a front view of the input interface of the long-range wireless vehicle command system 10. The display 24 and the keypad 26 are preferably located on the front face of the device 10. The display 24 displays the current time and the preset times for which the device 10 is to send a command to the remote vehicle starter as discussed previously. The keypad 26 includes a start key 100, a lock key 102 and an unlock key 104 that correspond to the START, LOCK and UNLOCK commands respectively. Other keys for other commands may be added as the need arises. The keypad 26 further includes a read button 106, a select button 108 and a menu button 110. These keys are used in conventional pager devices. The read button 106 is used to turn the device on and off and navigate through menus such as setting preset remote activation times. The select button 108 is used to select settings and features. The menu button 110 is used to access menus and to turn on an optional backlight for lighting the display 24.

It can be appreciated that by using pager technology the long-range wireless vehicle command system allows the vehicle owner to start the vehicle at a greater range than is currently available and to also unlock or lock the vehicle doors as well. For example, a user can be in a shopping mall and, through a simple call, start the vehicle in a remote location of the parking lot. Another example could be the case when the vehicle owner accidentally leaves the keys inside the vehicle and with just a call unlocks the doors in just a matter of seconds. If desired, the long-range wireless vehicle starter can be programmed such that for any of the three triggering activities, i.e. telephone call, timer activation or keypad activation, repeating the START command can be used to shut the engine vehicle off. In addition, there is no need to replace existing remote vehicle starters in order to use the long-range wireless vehicle command system since the transmitter of the long-range wireless vehicle command system can be adapted to interface with a wide variety of remote vehicle starters that are currently available on the market.

It should be understood that various modifications can be made to the preferred embodiments described and illustrated herein, without departing from the present invention.

1. A long-range wireless vehicle system for allowing a vehicle user to remotely command a remote vehicle starter located in a vehicle, the long-range wireless vehicle system comprising:
a) a wireless device for receiving a first wireless command signal, the first wireless command signal encoding a vehicle command;
b) a pulse generator connected to the wireless device for generating a second command signal based on the vehicle command; and,
c) a transmitter connected to the pulse generator for transmitting a second wireless command signal to the remote vehicle starter, the second wireless command signal encoding the vehicle command.

2. The system of claim 1, wherein the pulse generator comprises:
a) a signal conditioner connected to the wireless device for generating an intermediate command signal; and,
b) a comparator unit connected to the signal conditioner for comparing the intermediate command signal with a reference signal for identifying the vehicle command and providing a comparator output signal.

3. The system of claim 2, wherein the system further comprises a keypad connected to the pulse generating for providing a keypad command signal encoding the vehicle command.

4. The system of claim 3, wherein the system further comprises a clock connected to the pulse generator for providing a timer command signal encoding the vehicle command.

5. The system of claim 4, wherein the wireless device is a pager and the pager provides the clock.

6. The system of claim 1, wherein the vehicle command is one of START, LOCK and UNLOCK.

7. The system of claim 4, wherein the pulse generator further comprises:
iii) a master oscillator connected to the signal conditioner for generating the reference signal.

8. The system of claim 7, wherein the pulse generator further comprises:
iv) a buffer unit connected to the comparator unit and the transmitter unit for generating the second command signal in response to at least one of the comparator output signal and the keypad command signal and providing the second command signal to the transmitter.

9. The system of claim 8, wherein the comparator unit comprises N comparators and the buffer unit comprises N buffers where N is the number of different vehicle commands.

10. The system of claim 1, wherein the signal conditioner comprises a voltage isolator and level corrector connected to the wireless device for electrically isolating the wireless device from the pulse generator and shifting the voltage level of the first command signal for generating the intermediate command signal, and the signal conditioner further comprises a differentiating network connected to the voltage isolator and level corrector for generating a trigger signal.

11. A method for commanding a remote vehicle starter located in a vehicle, the method comprising:
a) transmitting a first long-range wireless command signal encoding a vehicle command;
b) receiving the first long-range wireless command signal and generating a short-range command signal based on the vehicle command; and,
c) generating and transmitting a short-range wireless command signal to the remote vehicle starter, the short-range wireless command signal encoding the vehicle command.

12. The method of claim 11, wherein step (b) of the method further comprises:
i) generating an intermediate command signal;
ii) generating a reference signal; and,
iii) comparing the intermediate command signal with the reference signal for identifying the vehicle command and providing a comparator output signal.

13. The method of claim 11, wherein the method further comprises providing a keypad command signal encoding the vehicle command.

14. The method of claim 11, wherein the method further comprises providing a timer command signal encoding the vehicle command.

15. The method of claim 13, wherein step (c) of the method further comprises generating the short-range wireless command signal based on at least one of the comparator output signal and the keypad command signal.
